(19) United States
(12) Patent Application Publication
(10) Pub. No.: US 2013/0218603 A1
(43) Pub. Date: Aug. 22, 2013

(54) SYSTEMS AND METHODS FOR INSURANCE BASED UPON CHARACTERISTICS OF A COLLISION DETECTION SYSTEM

(71) Applicants: Peter L. Hagelstein, Carlisle, MA (US); Jeffrey J. Hagen, Plymouth, MN (US); Roderick A. Hyde, Redmond, WA (US); Jordin T. Kare, Seattle, WA (US); Victoria Y.H. Wood, Livermore, CA (US)

(72) Inventors: Peter L. Hagelstein, Carlisle, MA (US); Jeffrey J. Hagen, Plymouth, MN (US); Roderick A. Hyde, Redmond, WA (US); Jordin T. Kare, Seattle, WA (US); Victoria Y.H. Wood, Livermore, CA (US)

(73) Assignee: Elwha LLC, Bellevue, WA (US)

(21) Appl. No.: 13/401,566

(22) Filed: Feb. 21, 2012

(51) Int. Cl. G06Q 40/08

(52) U.S. Cl. 705/4

(57) ABSTRACT

A property of an insurance policy may be determined, at least in part, upon characteristics of a vehicle collision detection system. The characteristics may pertain to any capability, configuration, and/or operating state of the collision detection system (and/or vehicle). For example, a property of the insurance policy may be based upon whether the collision detection system is configured to take automatic collision avoidance actions in response to detecting a potential collision and/or whether the automatic collision avoidance actions can be overridden by the operator of the vehicle. The property of the insurance policy may be dynamic, and may be updated in response to changes to the collision detection system and/or the real-time operating state thereof. The coverage of particular events may be based upon characteristics of the collision detection system and/or vehicle at the time the event occurred.

### TECHNICAL FIELD

This disclosure relates to systems and methods for determining a property an insurance policy based, at least in part, upon characteristics of a collision detection system.

### SUMMARY

One or more properties of an insurance policy may be based, at least in part, upon a characteristic of a collision detection system of a vehicle. As used herein, a collision detection system refers to any system for detecting a potential collision between a vehicle and another object, such as one or more vehicles, road hazards, obstructions, pedestrians, animals, or the like. An “insurance policy” refers to risk-transference contract between an insurer and an insured (policy provider and policy holder) in which the insurer agrees to satisfy qualifying claims brought by the insured. An insurance policy may include, but is not limited to, one or more of: a vehicle insurance policy, a health insurance policy, a life insurance policy, a disability insurance policy, a workers' compensation insurance policy, a group insurance policy, or the like. The “insurer” may be any entity responsible for satisfying claims under the insurance policy, and may include an agent of the insurer (e.g., employee, independent contractor, or other authorized entity), an underwriter, a re-insurer, or the like. As used herein, an insurance policy may pertain to any asset or entity including, but not limited to: a vehicle, a fleet of vehicles, an operator of a vehicle, a passenger of a vehicle, an owner of a vehicle, an entity having a security interest in a vehicle, an entity having a relationship with an operator, a passenger, and/or an owner of the vehicle (e.g., an employer of the vehicle operator), and so on. As used herein, a “property” of an insurance policy includes, but is not limited to, one or more of: a term of the insurance policy, eligibility for coverage under the insurance policy, a premium of the insurance policy, a coverage amount of the insurance policy, a deductible of the insurance policy, a rider of the insurance policy, a limitation of the insurance policy, a coverage scope of the insurance policy, the coverage of a particular event under the insurance policy, or the like. Although the specific example of insurance policies are disclosed herein, the disclosure is not limited in this regard and could be adapted to any suitable risk-transference and/or risk-mitigation mechanisms.

Characteristics upon which a property of an insurance policy may be based may include capabilities of the collision detection system, the configuration of the collision detection system, the operating state of the collision detection system (and/or vehicle), and so on. Examples of such characteristics include, but are not limited to: whether the vehicle has a collision detection system; an identifier of the vehicle collision detection system (e.g., model name, manufacturer, version, firmware revision, etc.); sensors utilized by the collision detection system; the vehicle collision detection system configuration; the operational mode of the collision detection system (e.g., whether the collision detection system is configured to automatically take collision avoidance actions and/or whether these automatic actions can be overridden by an operator of the vehicle); collision detection system specifications, such as response time, detection range, and the like; cooperative capabilities (e.g., ability to communicate collision detection information with other entities); recording functionality; usage and/or configuration history of the collision detection system; and so on. Accordingly, a collision detection system characteristic may refer to a static characteristic of the collision detection system (e.g., the capabilities of the system), a dynamic characteristic, and/or an operating state of the collision detection system and/or vehicle. Although particular examples of collision detection system characteristics are described herein, the disclosure is not limited in this regard; the teachings of this disclosure could be adapted to determine insurance policy properties using any collision detection system characteristic.

In some embodiments, an insurer (or agent thereof) accesses a characteristic of a collision detection system of a vehicle. The insurer may determine one or more properties of the insurance policy based upon the characteristic. The property of the insurance policy may be determined as the policy is being established. Alternatively, or in addition, the property of the insurance policy may be dynamic, and may change as updated and/or revised characteristics are received. For example, a property of the insurance policy may change depending upon usage characteristics of the collision detection system (e.g., a comparison of vehicle operating time during which the collision detection system was active to operating time during which the collision detection system was not active). In another example, a coverage limit of the insurance policy for a particular event (e.g., accident) may be based upon an operating state of the collision detection system (and/or vehicle) when the event occurred. Accordingly, the relationship between insurance policy properties and collision detection system characteristics disclosed herein may create economic incentives promoting the deployment and proper use of vehicle collision detection systems.

### BRIEF DESCRIPTION OF THE DRAWINGS

FIG. 1 depicts one embodiment of an exemplary collision detection system.

FIG. 2 depicts one embodiment of a data structure comprising collision detection system characteristics.

FIG. 3 depicts one embodiment of a history of collision detection system characteristics.

FIG. 4 is a block diagram of one embodiment of a system for determining a property of an insurance policy based, at least in part, on a characteristic of a collision detection system.

FIG. 5 depicts one embodiment of a document corresponding to an insurance policy data structure that comprises a property based, at least in part, on a characteristic of a collision detection system.

FIG. 6 depicts another embodiment of a document corresponding to an insurance policy data structure that comprises a property based, at least in part, on a characteristic of a collision detection system.

FIG. 7 depicts another embodiment of a document corresponding to an insurance policy data structure that comprises a property based, at least in part, on a characteristic of a collision detection system.

FIG. 8 is a flow diagram of one embodiment of a method for determining a property of an insurance policy based, at least in part, on a characteristic of a collision detection system.

FIG. 9 is a flow diagram of another embodiment of a method for determining a property of an insurance policy based, at least in part, on a characteristic of a collision detection system.

FIG. 10 is a flow diagram of one embodiment of a method for determining a property of an insurance policy based, at least in part, on a characteristic of a collision detection system.

### DETAILED DESCRIPTION

One or more properties of an insurance policy may be based, at least in part, upon a characteristic of a vehicle collision detection system. The insurance policy may pertain to any asset or entity including, but not limited to: the vehicle itself, a fleet of vehicles, an operator of the vehicle, a passenger of the vehicle, an owner of the vehicle (or fleet of vehicles), an entity having a security interest in the vehicle (or fleet of vehicles), an entity having a relationship with an operator and/or passenger of the vehicle (e.g., an employer of the vehicle operator), or the like. Accordingly, the insurance policy may include, but is not limited to, one or more of: an asset insurance policy (e.g., vehicle insurance policy), a liability insurance policy, a health insurance policy, a life insurance policy, a disability insurance policy, a workers' compensation policy, a group insurance policy, an individual insurance policy, or the like. The teachings of the disclosure are not limited to insurance policies, and could be adapted to any risk-transference and/or risk-mitigation mechanism.

The property of the insurance policy may be determined before or after the insurance policy is in effect (e.g., to update or modify the property of the insurance policy). In some embodiments, the property may be determined with respect to a particular event and may be based, at least in part, upon the capabilities, configuration, and/or operating state of the collision detection system (and or vehicle) at the time of the event (e.g., accident). The relationship between the insurance policy property and the characteristic of the collision detection system may create an incentive for the insured to deploy (and properly use and configure) the collision detection system.

Some of the infrastructure that can be used with embodiments disclosed herein is already available, such as: general-purpose computers, RF tags, RF antennas and associated readers, cameras and associated image processing components, microphones and associated audio processing components, computer programming tools and techniques, digital storage media, and communication networks. A computing device may include a processor such as a microprocessor, microcontroller, logic circuitry, or the like. The processor may include a special purpose processing device such as application-specific integrated circuits (ASIC), programmable array logic (PAL), programmable logic array (PLA), programmable logic device (PLD), field programmable gate array (FPGA), or other customizable and/or programmable device. The computing device may also include a machine-readable storage device such as non-volatile memory, static RAM, dynamic RAM, ROM, CD-ROM, disk, tape, magnetic, optical, flash memory, or other machine-readable storage medium.

Various aspects of certain embodiments may be implemented using hardware, software, firmware, or a combination thereof. As used herein, a software module or component may include any type of computer instruction or computer executable code located within or on a machine-readable storage medium. A software module may, for instance, comprise one or more physical or logical blocks of computer instructions, which may be organized as a routine, a program, an object, a component, a data structure, etc. that performs one or more tasks or implements particular abstract data types.

In certain embodiments, a particular software module may comprise disparate instructions stored in different locations of a machine-readable storage medium, which together implement the described functionality of the module. Indeed, a module may comprise a single instruction or many instructions, and may be distributed over several different code segments, among different programs, and across several machine-readable storage media. Some embodiments may be practiced in a distributed computing environment where tasks are performed by a remote processing device linked through a communication network.

In the exemplary embodiments depicted in the drawings, the size, shape, orientation, placement, configuration, and/or other characteristics of tags, computing devices, advertisements, cameras, antennas, microphones, and other aspects of mobile devices are merely illustrative. Specifically, mobile devices, computing devices, tags, and associated electronic components may be manufactured at very small sizes and may not necessarily be as obtrusive as depicted in the drawings. Moreover, image, audio, and RF tags, which may be significantly smaller than illustrated, may be less intrusively placed and/or configured differently from those depicted in the drawings.

The embodiments of the disclosure will be best understood by reference to the drawings, wherein like parts are designated by like numerals throughout. The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In other instances, well-known structures, materials, or operations are not shown or described in detail to avoid obscuring aspects of this disclosure.

Thus, the following detailed description of the embodiments of the systems and methods of the disclosure is not intended to limit the scope of the disclosure, as claimed, but is merely representative of possible embodiments. In addition, the steps of a method do not necessarily need to be executed in any specific order, or even sequentially, nor do the steps need to be executed only once.

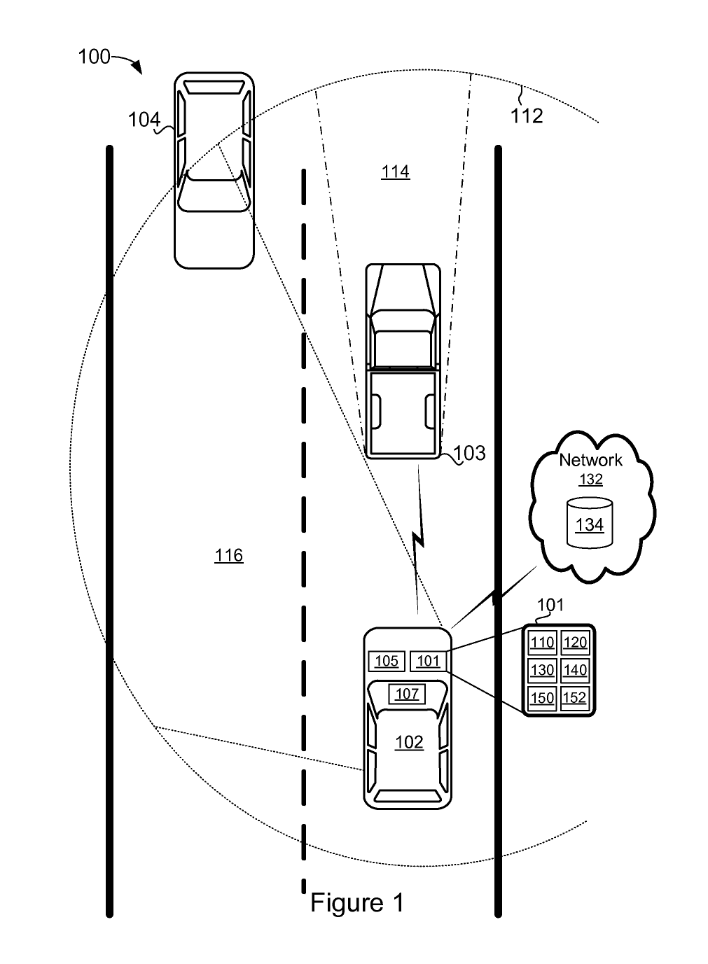

FIG. 1 is a block diagram 100 depicting one embodiment or an exemplary collision detection system 101. The collision detection system 101 may be deployed within a ground vehicle 102, such as a car, truck, bus, or the like. The collision detection system 101 may comprise a sensing system 110, a processing module 120, a communication module 130, a vehicle interface module 140, and a storage module 150. The sensing system 110 may be configured to acquire information pertaining to objects within a detection range 112 of the vehicle 102. The processing module 120 may use information obtained by the sensing system 110 (and/or other sources) to detect potential collisions. The communication module 130 may be used to communicate with other vehicles (e.g., vehicles 103 and/or 104), emergency service entities, information storage and retrieval services, and the like. The storage module 150 may be used to store information pertaining to the capabilities, configuration, and/or operating state of the collision detection system 101, vehicle 102 and/or other peri-collisional information.

The sensing system 110 may be configured to acquire information pertaining to objects that could pose a collision risk to the vehicle 102. The sensing system 110 may be further configured to acquire information pertaining to the vehicle 102 itself. The sensing system 110 may be configured to acquire kinematic information. As used herein, kinematics refers to motion characteristics of an object; kinematic information may include, but is not limited to: velocity, acceleration, orientation, and so on. Kinematic information may be expressed using any suitable reference system. Accordingly, kinematic information may be represented as component values, vector quantities, or the like.

The sensing system 110 may comprise one or more active and/or passive sensors, which may include, but are not limited to, one or more electro-magnetic sensing systems (e.g., radar sensing systems, capacitive sensing systems, and the like), electro-optical sensing systems (e.g., laser sensing system, Light Detection and Ranging (LIDAR) systems, and the like), acoustic sensing systems, imaging systems (e.g., cameras, image processing systems, stereoscopic cameras, etc.), information receiving systems (e.g., Global Positioning System (GPS) receiver, wireless network interface, etc.), and so on. The sensing system 110 may further comprise sensors for determining the kinematics of the vehicle 102. Accordingly, the sensing system 110 may comprise one or more speedometers, accelerometers, gyroscopes, or the like. Alternatively, or in addition, the sensing system 110 may comprise (or be communicatively coupled to) a control system 105 of the vehicle 102. As used herein, a vehicle “control system” refers to a system for providing control inputs to the vehicle, such as a steering, a braking, acceleration, and so on. The vehicle control system 105 may comprise sensors for determining velocity, acceleration, braking performance (e.g., an anti-lock braking system), and the like, which may be leveraged by the collision detection system 101 (e.g., included as part of the sensing system 110). The sensing system 110 may be configured to monitor control system inputs 105 to predict changes to vehicle kinematics (e.g., predict changes to acceleration based upon operator control of accelerator and/or braking inputs). Although particular examples of sensing systems are provided herein, the disclosure is not limited in this regard and could incorporate any sensing system 110 comprising any type of sensors.

The sensing system 110 may be capable of acquiring information pertaining to objects within a detection range 112 of the vehicle 102. As used herein, a “detection range” of the sensing system 110 refers to a range at which the sensing system 110 is capable of (and/or configured to) acquire information. In some embodiments, the detection range 112 may be more limited than the maximum detection range of the sensing system 110 (the maximum range at which the sensing system 110 can reliably acquire information). The detection range 112 may be set by user configuration and/or may be determined automatically based upon operating conditions of the vehicle 102, such as vehicle velocity and/or direction, velocity of other objects, weather conditions, and so on. For example, the detection range 112 may be reduced in response to the vehicle 102 traveling at a low velocity and may expand in response to the vehicle 102 traveling at higher velocities. Similarly, the detection range 112 may be based upon the velocities of other objects in the vicinity of the vehicle 102. For example, the detection range 112 may expand in response to detecting another vehicle 103 travelling at a high velocity relative to the vehicle 102, even though the vehicle 102 is traveling at a low velocity.

In some embodiments, the sensing system 110 may comprise directional sensors (e.g., a beam forming radar, phased array, or the like). The collision detection system 101 may shape and/or direct the detection range 112 of the sensing system 110 in response to operating conditions. For example, when the vehicle 102 is travelling forward at a high velocity, the detection range 112 may be directed toward the front of the vehicle 102; when the vehicle 102 is turning, the detection range 112 may be steered in the direction of the turn; and so on.

The collision detection system 101 may cooperate with other vehicles using the communication module 130. The communication module 130 may include, but is not limited to, one or more: wireless network interfaces, cellular data interfaces, satellite communication interfaces, electro-optical network interfaces (e.g., infrared communication interfaces), and the like. The communication module 130 may be configured to communicate in vehicle-to-vehicle “ad-hoc” networks and/or infrastructure networks 132, such as the Internet. The collision detection system 101 may use the communication module 130 to share information with other vehicles (e.g., share sensor information with other collision detection systems) and/or cooperate with other collision detection systems. For instance, the collision detection system 101 may configure the sensing system 110 in cooperation with other vehicles. This cooperation may allow the collision detection system 101 to obtain information pertaining to areas that are outside of the detection range 112 of the sensing system 110 and/or are obscured by other objects. For example, as depicted in FIG. 1, the position of vehicle 103 may prevent the sensing system 110 from reliably detecting objects in area 114. The collision detection system 101 may, therefore, request information pertaining to the area 114 from another source, such as the vehicle 103 or 104.

The collision detection system 101 may be further configured to provide information to other collision detection systems (e.g., a collision detection system of vehicle 103). Providing this information may comprise configuring the sensing system 110 in cooperation with the other vehicles. For example, the sensing system 110 may be capable of obtaining reliable, accurate information pertaining to objects in a particular area 116, but may not be capable of reliably obtaining information pertaining to objects in other areas (e.g., area 114). The collision detection system 101 system may coordinate with other vehicles to provide those vehicles with information pertaining to objects in area 116. In exchange, the other vehicles may provide the collision detection system 101 with information pertaining to objects in other areas, such as area 114. This coordination may comprise the collision detection system 101 configuring the detection range 112 of the sensing system 110 (e.g., by beam forming, steering, or the like) to acquire information pertaining to area 116 to the exclusion of other areas that will be provided by the other vehicles.

The collision detection system 101 may further comprise a processing module 120, which may use the information acquired by the sensing system 110 (and/or obtained from other sources via the communication module) to detect potential collisions. The processing module 120 may comprise one or more processors, including, but not limited to: a general-purpose microprocessor, a microcontroller, logic circuitry, an ASIC, an FPGA, PAL, PLD, PLA, and the like. The processing module 120 may further comprise volatile memory, persistent, machine-readable storage media 152, and the like. The persistent machine-readable storage media 152 may comprise instructions configured to cause the processing module to configure the sensing system 110, coordinate with other collision detection systems, detect potential collisions, and so on, as described herein.

The processing module 120 may be configured to detect potential collisions using information acquired from the sensing system 110 and/or obtained from other sources via the communication module 130. The processing module 120 may detect potential collisions using any suitable technique. In some embodiments, the processing module 120 detects potential collisions using a collision detection model. As used herein, a “collision detection model,” refers to a kinematic object model, which may comprise information pertaining to the kinematics of objects relative to the vehicle 102, such as relative velocity, acceleration, closing rate, orientation, and so on. Alternatively, or in addition, the collision detection model may comprise an “absolute” model, which includes kinematics of objects in the vicinity of the vehicle 102 along with kinematics of the vehicle 102 itself. The processing module 120 may detect potential collisions using the collision detection model. The processing module 120 may also make portions of the collision detection model available to other vehicles (via the communication module 130) and/or may incorporate collision detection models generated by other vehicles. The processing module 120 may be further configured to detect potential collisions involving other vehicles (e.g., vehicles 103 and/or 104) and/or determine a result of the potential collision (e.g., estimate object kinematics after the collision).

The collision detection system 101 may be configured to take one or more actions in response to detecting a potential collision. Such actions may include, but are not limited to: alerting the operator of the vehicle to the potential collision, determining a collision avoidance action, determining a potential result of the collision (e.g., estimate object kinematics after the collision), determining actions to avoid the potential result, automatically taking one or more collision avoidance actions, transmitting collision detection information to other vehicles, coordinating a response to the potential collision with other vehicles, contacting an emergency services entity, and so on.

The collision detection system 101 may comprise and/or be communicatively coupled to human-machine interface components 107 of the vehicle 102. The human-machine interface components 107 may include, but are not limited to: visual display components (e.g., display screens, heads-up displays, or the like), audio components (e.g., a vehicle audio system, speakers, or the like), haptic components (e.g., power steering controls, force feedback systems, or the like), and so on.

The collision detection system 101 may use the human-machine interface components 107 to alert an operator of the vehicle 102 to a potential collision. The alert may comprise one or more of: an audible alert (e.g., alarm), a visual alert, a haptic alert, or the like. In some embodiments, the alert may comprise collision avoidance instructions to assist the operator in avoiding the potential collision (and/or a result of a potential collision involving other vehicles). The avoidance instructions may be provided as one or more audible instructions, visual cues (e.g., displayed on a heads-up-display), haptic stimuli, or the like. For example, collision avoidance instructions may be conveyed audibly through a speaker system of the vehicle (e.g., instructions to “veer left”), visually through icons on a display interface (e.g., a turn icon, brake icon, release brake icon, etc.), and/or by haptic feedback (e.g., vibrating a surface, actuating a control input, and so on). Although particular examples of alerts are described herein, the disclosure is not limited in this regard and could be adapted to incorporate any suitable human-machine interface components 107.

As discussed above, the collision detection system 101 may be configured to take one or more automatic collision avoidance actions in response to detecting a potential collision. The collision avoidance actions may include, but are not limited to: accelerating, decelerating, turning, actuating vehicle systems (e.g., lighting systems, horn, etc.), and so on. Accordingly, the collision detection system 101 may be communicatively coupled to the control system 105 of the vehicle 102, and may be capable of providing control inputs thereto. The automatic collision avoidance actions may be configured to prevent the potential collision, avoid a result of the potential collision (e.g., a collision involving other vehicles), and so on. The automatic collision avoidance actions may be determined in cooperation other vehicles. For example, the collision detection system 101 may cooperate with the vehicle 103 to determine collision avoidance actions (or instructions) that allow both vehicles 102,103 to avoid the potential collision, while also avoiding each other.

The collision detection system 101 may be configured to implement the automatic collision avoidance actions without the consent and/or intervention of the vehicle operator. Alternatively, or in addition, the collision detection system 101 may request consent from the operator before taking the automatic collision avoidance actions. The human-machine interface module 107 may comprise one or more inputs configured to allow the vehicle operator to indicate consent, such as a button on a control surface (e.g., steering wheel), an audio input, a visual input, or the like. The consent may be requested at the time a potential collision is detected and/or may be requested a priori, before a potential collision is detected. The consent may expire after a pre-determined time and/or in response to certain, pre-determined conditions (e.g., after the potential collision has been avoided, after the vehicle 102 is shut down, etc.). Accordingly, the collision detection system 101 may be configured to periodically re-request the consent of the vehicle operator. For example, the collision detection system 101 may request consent to implement automatic collision avoidance actions each time the vehicle 102 is started.

The collision detection system 101 may be configured such that the automatic collision avoidance actions cannot be overridden by the vehicle operator. Accordingly, the collision detection system 101 may be configured to “lock out” the vehicle operator from portions of the control system 105. Access to the vehicle control system 105 may be restored after the automatic collision avoidance actions are complete and/or the collision detection system 101 determines that the potential collision has been avoided. The collision detection system 101 may be configured to “lock out” the vehicle operator from all vehicle control operations. Alternatively, the vehicle operator may be allowed limited access to the control system 105. For example, the control system 105 may accept operator inputs that do not interfere and/or conflict with the automatic collision avoidance actions (e.g., the vehicle operator may be allowed to provide limited steering input, but not acceleration/deceleration).

Alternatively, the collision detection system 101 may be configured to allow the vehicle operator to override one or more of the automatic collision avoidance actions. In response to an override, the collision detection system 101 may stop implementing automatic collision avoidance actions and may return control to the vehicle operator. An override may comprise the vehicle operator providing an input to the control system 105 (or other human-machine interface component 107). In another example, the collision detection system 101 may implement the automatic collision avoidance actions by actuating controls of the vehicle 102 (e.g., turning the steering wheel), and an override may comprise the vehicle operator resisting or counteracting the automatic control actuations.

In some embodiments, the collision detection system 101 may be capable of and/or configured to preemptively deploy safety systems of the vehicle 102. For example, the collision detection system 101 may be configured to deploy one or more airbags before the impact of the collision occurs. The collision detection system 101 may be further configured to adapt the deployment of the safety systems to the imminent collision (e.g., adapt safety system deployment in accordance with the location on the vehicle 102 where a collision impact is to occur).

The collision detection system 101 may continue to monitor object kinematics after detecting a potential collision and taking any of the actions described above. The collision detection system 101 may continue to revise and/or update the actions described above in response to changing kinematics (e.g., the result of one or more collisions, the actions of other vehicles 103,104, and the like).

The collision detection system 101 may further comprise a storage module 150 that is configured to store information pertaining to the capabilities, configuration, and/or operating state of the collision detection system 101 (and/or vehicle 102). The storage module 150 may comprise persistent storage media 152, such as hard disks, solid-state storage, optical storage media, or the like. Alternatively, or in addition, the storage module 150 may be configured to store data in a network-accessible storage service 134, such as a cloud storage service or the like (via the communication module 130).

The storage module 150 may be configured to store any information pertaining to the vehicle 102, which may include, but is not limited to: kinematics of the vehicle 102, operator control inputs (e.g., steering, braking, etc.), collision detection information such as the capabilities and/or configuration of the collision detection system 101, kinematics of other vehicles, collision detections, actions taken in response to detecting potential collisions, operator override of automatic collision avoidance actions, communication with other vehicles, and so on. Accordingly, the storage module 150 may act as a “black box” detailing the operating conditions of the vehicle 102 and/or other peri-collisional circumstances.

The storage module 150 may be configured to prevent unauthorized access to and/or modification of stored information. Accordingly, the storage module 150 may be configured to encrypt information for storage. The storage module 150 may also provide for validating authenticity of stored information; for example, the storage module 150 may be configured to cryptographically sign stored information.

The characteristics of the collision detection system 101 described above may be embodied within a data structure, which may be stored on a machine-readable storage medium (e.g., storage medium 152) and/or conveyed on a communication network (e.g., network 132). An insurer (or other entity) may determine one or more properties of an insurance policy based upon the contents of the data structure.

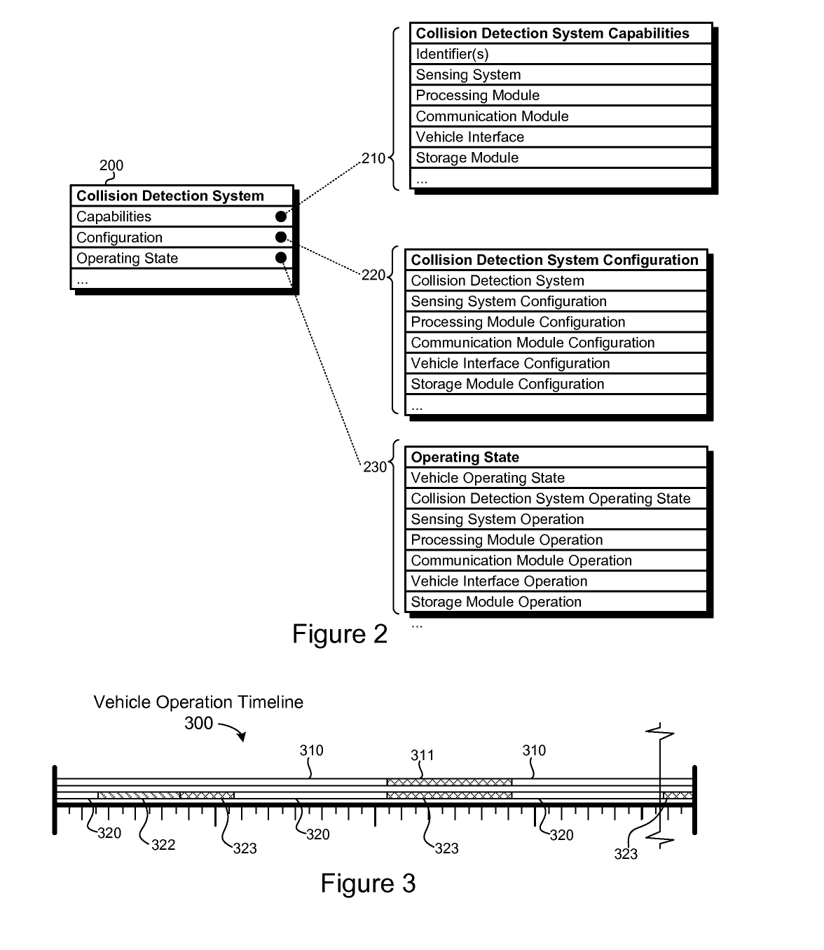

FIG. 2 depicts one embodiment of a data structure 200 comprising characteristics of a collision detection system 101, which may include, but are not limited to: data 210 pertaining to the capabilities of the collision detection system 101, data 220 pertaining to the configuration of the collision detection system 101, data 230 pertaining to the operating state of the collision detection system 101 and/or vehicle 102, and so on.

The data 210 may specify the capabilities of the collision detection system 101. The data 210 may include information from which capabilities may be determined, such as an identifier (e.g., name and/or model number) of the collision detection system 101, certifications of the collision detection system 101, and so on. The data 210 may comprise information pertaining to particular modules and/or systems of the collision detection system 101, such as the capabilities of the sensing system 110, processing module 120, communication module 130, vehicle interface module 140, and/or storage module 150, described above. The data 210 pertaining to the sensing system may specify the sensors available to the collision detection system 101, the detection range of the sensing system 110, accuracy of the sensing system 110, cooperative features of the sensing system 110 (e.g., the ability to share sensor data, coordinate sensor operation with other vehicles, etc.), and so on. The data 210 pertaining to the processing module 120 may specify the processing resources available to the collision detection system 101, the response time of the collision detection system 101, the collision detection model employed by the system 101, and so on. Data 210 pertaining to the communication module 130 may specify whether the collision detection system 101 is capable of communicating with other vehicles, communicating with a wide-area network 132 (e.g., the Internet, satellite network, wireless, etc.), and so on. Data 210 pertaining to the vehicle interface module 140 may specify the actions (if any) the collision detection system is capable of taking in response to detecting a potential collision. As discussed above, such actions may include, but are not limited to: notifications, collision avoidance instructions, automatic collision avoidance actions, preemptive safety system deployment, inter-vehicle coordination, and so on. Data 210 pertaining to the storage module 150 may indicate whether the collision detection system 101 is capable of storing data pertaining to the operating state of the system 101 and/or vehicle 102, security measures of the storage system 150, storage capacity, and so on.

The data 220 may describe the configuration of the collision detection system 101. The data 220 may indicate how the collision detection system 101 is configured to use the capabilities identified in the data 210. The data 220 may comprise a current configuration of the collision detection system 101 (e.g., current operating state), may comprise static configuration data (e.g., configuration information that cannot be changed or can be changed only under certain circumstances), a history (e.g., time-based data or log describing the configuration of the collision detection system 101 over time), or the like.

The data 220 may specify whether the collision detection system 101 is active and enabled (e.g., configured to detect potential collisions). The data 220 may further comprise configuration information of individual systems and/or modules of the collision detection system 101. Configuration data 220 pertaining to the sensing system 110 may specify which sensors are enabled, calibration information pertaining to the sensors, whether the sensing system 110 is configured to communicate and/or cooperate with other vehicles, and so on. Configuration data 220 pertaining to the processing module 120 may specify whether the processing module is configured to share collision detection information with other vehicles (e.g., the collision detection model), coordinate collision avoidance actions with other vehicles, and so on. Configuration data 220 pertaining to the communication module 130 may specify whether the communication module 130 is configured to discover other vehicles (e.g., broadcast to other vehicles), configured to accept broadcast messages from other vehicles, and so on. Configuration data 220 pertaining to the vehicle interface 140 may specify the actions (if any) the collision detection system 101 is configured to take in response to detecting a potential collision. As described above, such actions may include, but are not limited to: alerting an operator of the vehicle to the potential collision, providing instructions for avoiding the potential collision, taking one or more automatic collision detection actions, and so on. The data 220 may further specify whether any of the actions can be overridden by the vehicle operator, and may specify the conditions under which the operator may override the actions. Data 220 pertaining to the storage module 150 may specify whether the collision detection system is configured to persistently store (and/or communicate) information pertaining to the operation of the vehicle 102 and/or the collision detection system 101 (e.g., vehicle kinematics, kinematics of other vehicles, etc.), and so on.

As discussed above, the data structure 200 may comprise a history (e.g., time-based record or log) pertaining to the collision detection system 101 and/or vehicle 102. FIG. 3 depicts one example of a history pertaining to the configuration of a collision detection system 101. The data illustrated in FIG. 3 could be included in the data structure 200 (or other suitable data structure) for use in determining one or more properties of an insurance policy, as described herein. The data depicted in FIG. 3 relates to a vehicle operation timeline 300. The timeline 300 may be contiguous (e.g., an “absolute” timeline). Alternatively, the timeline 300 may be discontiguous and include only the time during which the vehicle is in operation (e.g., the vehicle is on or in motion) and/or the collision detection system 101 is enabled. In another example, the timeline 300 may be used to identify the operating state of the collision detection system 101 (and/or vehicle 102) at the time of a particular event.

In the FIG. 3 example, the time regions 310 identify the time during which the collision detection system 101 was active (e.g., enabled to detect potential collisions and/or take corresponding collision avoidance actions). The time regions 311 indicate the time during which the collision detection system was inactive (e.g., not enabled). The history of FIG. 3 may further comprise data pertaining to the configuration of particular systems and/or modules of the collision detection system 101. For example, the time regions 320 may identify the time during which the collision detection system was configured to take automatic collision avoidance actions that could not be overridden by the vehicle operator. The time region 322 may identify the time during which the automatic collision avoidance actions were overridable by the vehicle operator. And the time regions 323 may identify the times during which the collision detection system was not configured to take automatic collision avoidance actions (e.g., the collision detection system was disabled and/or configured to only provide alerts and/or collision avoidance instructions). Although the history of FIG. 3 depicts examples of particular characteristics, the disclosure is not limited in this regard, and the data structure 200 (or other suitable data structures) could be adapted to incorporate history data pertaining to any capability, configuration, and/or operating state of the collision detection system 101 and/or vehicle 102.

In some embodiments, data pertaining to the collision detection system 101 may be provided as a ratio or comparison. For example, the data structure 220 may include a value that compares the operation time during which the collision detection system was active versus the time during which the collision detection system was inactive. The comparison value may be derived from the history of FIG. 3. In some embodiments, comparison values may be used in place of, or in addition to, time-based data or logs (e.g., histories) in the data structure 200.

Referring back to FIG. 2, in some embodiments the data structure 200 may comprise information pertaining to operating state of the collision detection system 101 and/or vehicle 102. As discussed above, the operating state of the collision detection system 101 refers to a current configuration of the collision detection system 101 and/or the configuration (and use) of the collision detection system 101 at a particular time (e.g., at the time of an accident). The operating state data 230 may comprise information pertaining to the operation of the collision detection system 101, such as a record of potential collisions detected by the system 101, actions taken by the system 101, and so on. The data 230 may further comprise operational data pertaining to various systems and/or modules of the collision detection system 101, such as the sensing system 110, processing module 120, communication module 130, vehicle interface 140, storage module 150, and so on.

The operating state data 230 may further comprise information pertaining to the operation of the vehicle 102 (vehicle operating state), which may include, but is not limited to: kinematics of the vehicle, operator inputs, operator overrides, operating conditions (e.g., weather, vehicle diagnostics, etc.), vehicle position (e.g., GPS position), and so on. The operating state data 230 comprise kinematic data pertaining to other objects (e.g., vehicles 103 and/or 104), the collision detection model of the collision detection system 101, a record of communication and/or coordination with other vehicles, and so on. Accordingly, the operating data 230 may comprise “black box” type data, which may be used to reconstruct the circumstances leading up to a collision (or other event). The operating data 230 may be used to reconstruct an accident involving the vehicle 102, other vehicles (e.g., vehicles 103 and/or 104), or the like. The operating state data 230 may also allow the configuration and/or operation of the collision detection system 101 and/or vehicle 102 at a particular time or event (e.g., collision) to be determined. An insurance policy property may be determined, at least in part, based upon the operating state data (e.g., data 230) at the time the event occurred.

As discussed above, an insurer may use characteristics of a collision detection system 101 (e.g., the data structure 200) to determine a property of an insurance policy. The property of the insurance policy may be determined before the insurance policy is in effect (e.g., before the insurer and the insured enter into the contract defined by the insurance policy). Once the properties of the insurance policy are determined, the insurer and insured may enter into the insurance policy (e.g., formalize the insurance policy), which may cause the insurance policy to go into effect. Alternatively, or in addition, the property may be determined (or adjusted) after the insurance policy is in effect. Accordingly, one or more properties of the insurance policy may be dynamic, and may change in response to changes to the characteristics of the collision detection system 101.

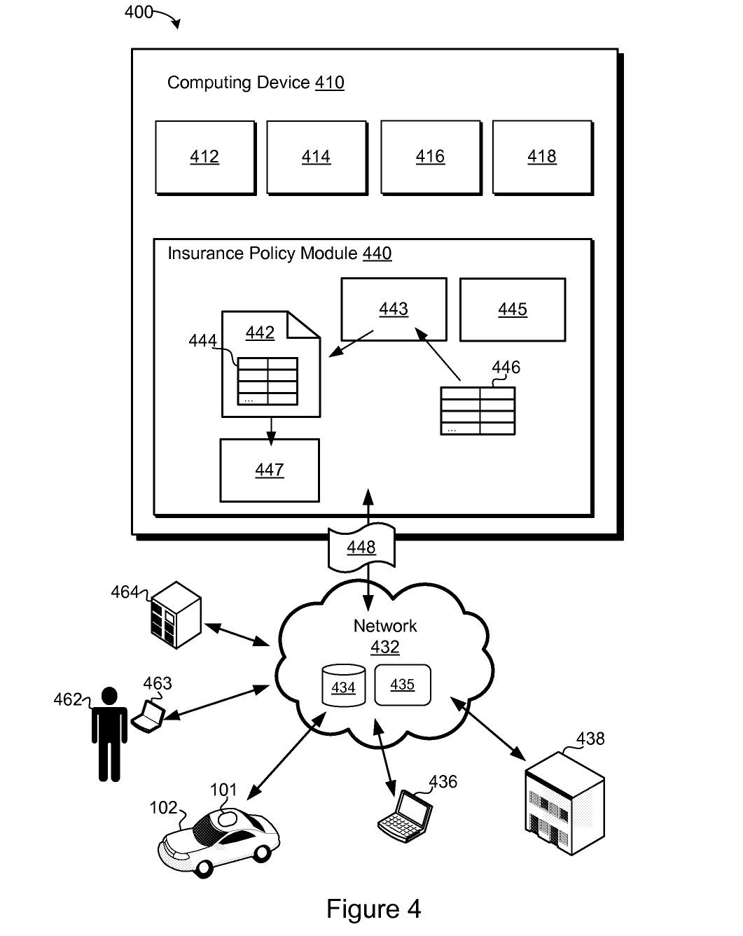

FIG. 4 is a block diagram of one embodiment of a system 400 for determining one or more properties of an insurance policy based upon characteristics of a vehicle collision detection system 101. The system 400 may comprise a computing device 410, which may comprise a processor 412, a memory 414, a communication interface 416, and persistent storage 418.

An insurance policy module 440 may operate on the computing device 410. The insurance policy module 440 may be embodied as one or more machine-readable instructions stored on a persistent storage media (e.g., storage media 418) and/or transmitted via a communication network (e.g., network 432). The instructions comprising the insurance policy module 440 may be configured for execution on the computing device 410 (e.g., on the processor 412 of the computing device 410). Alternatively, or in addition, portions of the insurance policy module 410 (as well as the other modules and systems disclosed herein) may be implemented using machine elements, such as processors, ASICs, FPGAs, PALs, PLDs, PLAs, or the like.

The insurance policy module 440 may be configured to determine one or more properties 444 of an insurance policy (insurance policy data structure 442) based upon characteristics 446 of a collision detection system (e.g., the collision detection system 101, described above).

The insurance policy data structure 442 may comprise one or more data structures stored on a machine-readable storage medium, such as the persistent storage 418. Alternatively, or in addition, portions of the insurance policy data structure 442 (and/or the properties 444 thereof) may be transmitted and/or communicated on the communication network 432 (e.g., may be stored in a network-accessible persistent storage service 434). The insurance policy data structure 442 may be implemented using any mechanism for representing information including, but not limited to: text (e.g., ASCII text), a database (e.g., as one or more database tables, records, attributes, or the like), markup language (e.g., HTML, XML, delimited text, etc.), or the like. Accordingly, the properties 444 of the insurance policy data structure 442 may comprise one or more text values, name-value pairs, database elements (e.g., tables, attributes, etc.), XML elements, XML attributes, or the like.

As discussed above, the properties 444 may relate to any aspect of an insurance policy, including but not limited to: eligibility for coverage under the insurance policy, a premium of the insurance policy, a coverage amount of the insurance policy, a deductible of the insurance policy, a rider of the insurance policy, a limitation of the insurance policy, a coverage scope of the insurance policy, the coverage of a particular incident under the insurance policy, or the like.

One or more of the properties 444 may be determined by (e.g., based upon) characteristics 446 of a collision detection system 101. The collision detection system characteristics may be represented in a data structure 446, which may correspond to the data structure 200, described above. The insurance policy module 440 may access the characteristics 446 from any suitable data source, which may include, but is not limited to: the persistent storage medium 418, the vehicle 102 (e.g., transmitted directly from the vehicle 102 via the collision detection system 101 or other communication interface); a network-accessible storage service 434; a computing device 436 comprising information pertaining to the collision detection system 101 (e.g., a manufacturer database, vehicle service center, or the like); another entity 438, such as an insurance agency, insurer, or the like; or any other suitable source of information pertaining to the collision detection system 101 and/or vehicle 102.

The insurance policy module 440 may determine the properties 444 of the insurance policy data structure 442 using any suitable decision-making mechanism, including, but not limited to: lookup tables, a policy, rules 443, an expert system, a neural network, a machine-learning algorithm, or the like. In some embodiments, the insurance policy module 440 is configured to apply one or more rules 443 to determine properties 444 of the insurance policy data structure 442. For example, one of the rules 443 may specify that a property 444 corresponding to the premium of the insurance policy (e.g., cost of the insurance policy) is reduced by a particular amount (or percentage) in response to a characteristic 446 that indicates that the collision detection system 101 is configured to take automatic collision detection actions. Another one of the rules 443 may specify that the premium property 444 is further reduced when the characteristics 446 indicate that the automatic collision avoidance actions cannot be overridden by the vehicle operator. Accordingly, the insurer may promote the proper use of the collision detection system 101 by creating rules 443 that provide incentives for the vehicle operator to cede control of the vehicle 102 under certain circumstances.

In another example, the insurer may define rules 443 that incentivize vehicle-to-vehicle cooperation. For example, a rule 443 may provide favorable properties 444 (e.g., reduced premium or the like) in response to characteristics 446 that indicate that the collision detection system 101 is configured to share collision detection information and/or coordinate collision avoidance actions with other vehicles. Although examples of particular rules 443 are described herein, the disclosure is not limited in this regard and could be adapted to determine properties 444 of the insurance policy data structure 442 using any suitable mechanism and/or using any suitable set of rules 443.

In some embodiments, the insurance policy module 440 comprises a security module 445 that is configured to authenticate and/or verify the characteristics 446. The security module 445 may verify that the characteristics 446 originated from an authorized source (e.g., the collision detection system 101 itself, authorized personnel, or the like), have not be tampered with (e.g., not modified from their original values), and so on. In some embodiments, the characteristics 446 may comprise a digital signature (or other security mechanism) that can be used to verify the characteristics 446. Alternatively, or in addition, the characteristics 446 may be transmitted to the insurance policy module 440 via a secure communication mechanism, such as mutually authenticated secure sockets layer (SSL) connection, or the like. The security module 446 may leverage the secure communication mechanism to verify the characteristics 446.

The insurance policy module 440 may be configured to determine the properties 444 of the insurance policy data structure 442 before the insurance policy is in effect (e.g., before the insurer and insured enter into the insurance policy). In some embodiments, the insurance policy module 440 comprises a formalization module 447 that is configured to facilitate formalization of the insurance policy. As used herein, formalization refers to the insurer and the insured entering into an insurance policy contract as defined by the insurance policy data structure 442 and/or the properties 444 thereof. Accordingly, the formalization module 447 may be configured to provide the insurance policy data structure 442 (and/or a document 448 corresponding to the to the data structure 442) to an authorized entity 462 of the insured and/or an authorized entity 464 of the insurer, and receive acceptance therefrom. The authorized entity of the insured 462 and/or insurer 464 may be a person, an automated agent (e.g., computing device), or the like. An authorized entity 462 and/or 464 that is a person may interact with the insurance policy module 440 (and/or formalization module 447) via a computing device 463 (e.g., a laptop, notebook, tablet, smart phone, personal digital assistant, or the like).

The formalization module 447 may be configured to authenticate the identity of the authorized entities 462 and/or 464 and/or verify that the entities 462 and/or 464 are authorized to enter into an insurance policy contract on behalf of the insured and/or insurer. The formalization module 447 may authenticate and/or authorize the entities 462 and/or 464 using a digital signature, password, or other credential. In some embodiments, the formalization module 447 may be configured to authenticate and/or authorize the entities 462 and/or 464 using a network-accessible service 435, which may include, but is not limited to: a certificate authority (e.g., an X.509 certificate authority), an authentication authority, an identity service (e.g., a Security Assertion Markup Language (SAML) authentication authority, a Liberty Alliance Authenticating Authority, an OpenID® provider, a Microsoft Passport® service, a Microsoft Cardspace® service, etc.), or the like.

The formalization module 447 may be configured to provide the insurance policy data structure 442 to the authorized entities 462 and/or 464 via the network 432. In some embodiments, the formalization module 447 may be configured convert the insurance policy data structure 442 into a different format (e.g., different data format, data encoding, or the like). Alternatively, or in addition, the formalization module 447 may be configured to provide the entities 462 and/or 464 with the insurance policy data structure 442 in a human-readable format, such as a document 448. The document 448 may comprise an insurance contract that incorporates the properties 444 of the insurance policy data structure 442. The document 448 may be provided to the entities 462 and/or 464 via the network 432 as a web page, email, fax, or the like. The document may be configured for display on a computing device 463. Accordingly, the formalization module 447 may comprise (and/or be communicatively coupled to) a web server, email server, or the like. Alternatively, or in addition, the formalization module 447 may be configured to provide the entities 462 and/or 464 with a tangible document representing the insurance policy data structure 442 (e.g., a paper copy of an insurance policy).

The formalization module 447 may be further configured to request acceptance of an insurance policy contract in accordance with the insurance policy data structure 442. For example, the document 448 (e.g., insurance policy contract) may include a signature line (or signature input interface) that may receive a signature (or other indication of acceptance) from the authorized entities 462 and/or 464. The signature may comprise any suitable indication of acceptance, including, but not limited to: selection of an interface element (e.g., selecting a checkbox or other interface element of the document 448), a digital signature, a cryptographic signature, or the like. Alternatively, or in addition, the formalization module 447 may request acceptance via in a tangible document (e.g., paper document).

The formalization module 447 may be configured to receive indications of acceptance from the authorized entities 462 and/or 464. The indications may be received via the network 432, as described above. Alternatively, or in addition, acceptance may be received via a signature on a tangible document or the like. In response to receiving acceptance from the authorized entities 462 and 464, the formalization module 447 may update the insurance data structure 442. Updating may comprise indicating that the insurance policy data structure 442 is in effect (or is to go into effect at a particular time and/or under particular circumstances). The updated insurance policy data structure 442 may be stored in a persistent storage medium (e.g., persistent storage medium 418), transmitted via the network 432 (e.g., transmitted to the insured 462 and/or insurer 464), or the like, as described above. The formalization module 447 may be further configured to transmit confirmation of the insurance policy to the authorized entities 462 and/or 464.

In some embodiments, the formalization module 447 may indicate how the properties 444 of the insurance policy data structure 442 were determined. This information may allow the insured to reconfigure the collision detection system 101 to obtain favorable terms. For example, the formalization module 447 may indicate that the premium of the policy was determined based, at least in part, on whether the collision detection system 101 is configured to take non-overridable collision avoidance actions. In response, the authorized entity 462 may reconfigure the collision detection system 101 and resubmit the characteristics 446, which may result in a revised set of properties 444 (e.g., lowered premium). The information pertaining to the relationship between insurance policy properties 444 and collision detection system characteristics 446 may be presented in the document 448.

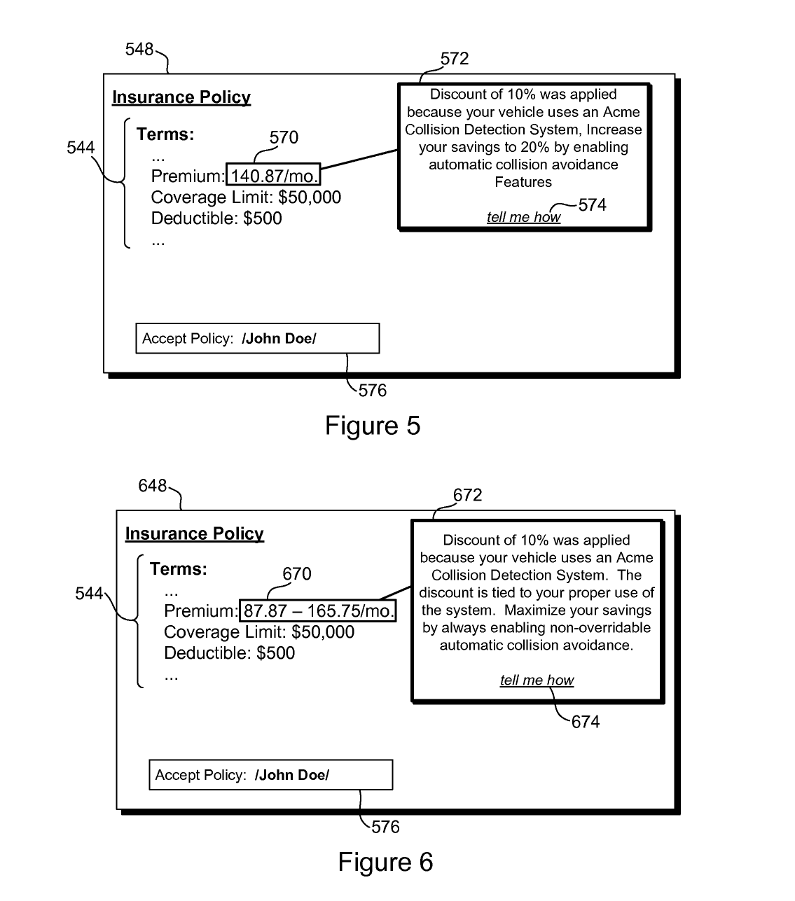

FIG. 5 depicts one example of a document 548 comprising information corresponding to the insurance policy data structure 444. The document 548 may be embodied as machine-readable data (e.g., markup data or the like), that is adapted for presentation on a display of a computing device. Alternatively, the document 548 may be embodied on a tangible media, such as a disk, Universal Serial Bus (USB) storage device, paper, or the like.

The document 548 may include a human-readable listing of various properties (e.g., terms) 544 of the policy. The properties 544 may correspond to the properties 444 of the insurance policy data structure 542. The document 548 may highlight a particular property 570 that is determined, at least in part, based upon one or more characteristics of the collision detection system 101. As depicted in the FIG. 5 example, the premium 570 of the policy is based upon collision detection system characteristics. The document 548 may include information indicating how the property 570 is affected by the collision detection system characteristic. In the FIG. 5 example, the document 548 includes a notice 572 that the premium 570 includes a 10 percent discount due to the use of a particular type of collision detection system. The notice indicates that premium 570 may be further reduced by configuring the collision detection system to take automatic collision avoidance actions, and may include a link 574 to instructions on how to perform the suggested configuration change. Although a particular example of a notice 572 is provided herein, the disclosure is not limited in this regard and could be adapted to use any notification mechanism corresponding to any property 544. For example, in other embodiments, the notice 572 may be communicated in a separate document (e.g., outside of the insurance policy document 548), may include configuration instructions (as opposed to the link 574), and so on.

The document 548 includes an input 576 through which an authorized entity 462 of the insured may indicate acceptance. As shown in the FIG. 5 example, the input 576 may comprise a text input box. However, the disclosure is not limited in this regard and could be adapted to include any suitable acceptance input.

Referring back to FIG. 4, in response to receiving updated characteristics 446, the insurance policy module 440 may re-determine the properties 444 of the insurance policy data structure 442, update the corresponding document 448, and/or notify the authorized entities 462 and/or 464 of any changes.

As discussed above, in some embodiments, a property 444 of the insurance policy data structure 442 may by dynamic, and may change in response to changes to the characteristics 446 of the collision detection system 101. Accordingly, the insurance module 440 may be configured to access updated characteristics 446, re-determine the property 444, and update the insurance policy data structure 442 accordingly. Updated characteristics 446 may be received continuously during operation of the vehicle 102. For example, the collision detection system 101 may be configured to store and/or transmit characteristics 446 in real-time during operation of the vehicle 102. Alternatively, or in addition, updated characteristics may be received in a non-continuous and/or non-real time manner. The characteristics 446 may be received in response to upgrading and/or servicing the collision detection system 101, vehicle 102, or the like. The updated characteristics 446 may be obtained from the storage module 150 of the collision detection system 101, from a network-accessible storage service 134, from another authorized source (e.g., entity 438), or the like.

The insurance policy module 440 may update a property 444 of the insurance policy data structure 442 in response to updated characteristics 446. For example, a premium of the insurance policy may be based upon how often the operator of the vehicle 102 configures the collision detection system 101 to take non-overridable automatic collision avoidance actions. The premium may be lower when the operator consistently configures the collision detection system 101 to take such actions; otherwise, a higher premium may apply. For instance, the premium may be based upon a comparison (e.g., ratio) of vehicle operation time during which the automatic collision avoidance actions are non-overridable to the time during which the actions are overridable.

The document 448 corresponding to the insurance policy data structure 442 may notify the insured of how dynamic properties (if any) are affected, and may identify the characteristics 446 upon which the dynamic properties are based. FIG. 6 depicts one example of a document 648 comprising information corresponding to a dynamic property 670 of an insurance policy. The document 648 may list the properties (e.g., terms) 544 of the insurance policy, as described above. The dynamic term 670 is highlighted, and the notice 672 indicates how the dynamic term 670 is affected by the configuration of the collision detection system 101. The notice 672 indicates that the insured can minimize the premium 670 by always enabling non-overridable automatic collision avoidance actions, and may provide a link to instructions on how to properly configure the collision detection system 101. The document 648 may further comprise an acceptance input 576, as described above.

Referring back to FIG. 4, one or more of the properties 444 of the insurance policy data structure 442 may specify how the insurance policy applies to particular events (e.g., a particular accident involving the vehicle 102). After an event occurs, the insurer may obtain information pertaining to the configuration of the collision detection system 101 and/or operator actions from the storage module 150, the network-accessible storage 434, or the like. This information may be used to determine a property 444 as it pertains to the particular event. For instance, an event-specific property 444 may determine a coverage limit for an accident, a deductible applied to the accident, or the like. An event-specific property 444 may specify the deductible of the policy, which may be based, at least in part, upon a characteristic 446 of the collision detection system 101 and/or actions of the operator at the time the accident occurred. The deductible may be lower if the accident occurred despite the automatic collision avoidance actions taken by the collision detection system 101, and may be higher if the operator overrode the actions, ignored instructions of the system 101, disabled the system 101, and so on.

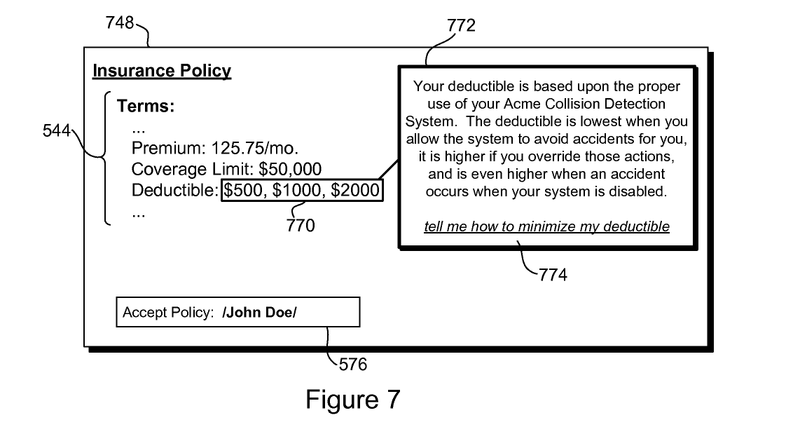

The document 448 corresponding to the insurance policy data structure 442 may notify the authorized entities 462 and/or 464 of how certain properties 444 affect the coverage of particular events (e.g., accidents). FIG. 7 depicts one example of a document 748 comprising information corresponding to an event-specific property (the insurance policy deductible 770). The document 748 enumerates the properties (e.g., terms) 544 of the policy as described above. The property 770 that defines the coverage of the policy for particular events is highlighted. The property 770 indicates that the deductible for an accident may be $500 to $2,000 depending on the configuration of the collision detection system 101 and/or the actions of the vehicle operator when the accident occurs. The notice 772 indicates how the characteristics 446 of the collision detection system 101 and/or operator actions affect the deductible 770. The variable deductible property 770 creates an incentive for the insured to allow automatic collision avoidance actions to take place, and discourages overriding and/or disabling such actions. The notice 772 may further include a link 774 to information on how to properly configure the collision detection system 101 to minimize the deductible 770.

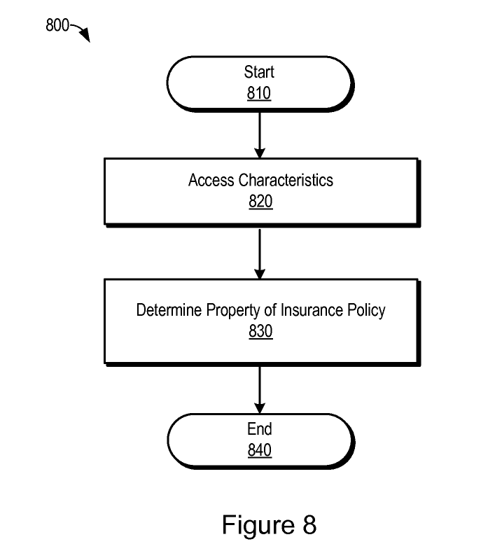

FIG. 8 illustrates a flow chart of one embodiment of a method 800 for determining a property of an insurance policy based upon information pertaining to a characteristic of a collision detection system. At step 810, the method 800 is started and is initialized. Step 810 may comprise accessing one or more machine-readable instructions in a non-volatile storage media, such as a hard disk, solid-state storage device, or the like. Step 810 may further comprise accessing one or more machine components, such as network interfaces, data storage resources (e.g., database connections), and so on.

Step 820 may comprise accessing information pertaining to the characteristics of a collision detection system 101. Step 820 may comprise receiving and/or parsing a data structure, such as the data structure 200 and/or 446 described above. The characteristics of step 820 may be received using any data communication mechanism including, but not limited to: receiving the characteristics via a network, reading the characteristics from a machine-readable storage medium, accessing the characteristics from a data storage service (e.g., a database, a network-accessible storage service, etc.), or the like. The characteristics of step 820 may comprise capabilities of the collision detection system 101 (e.g., data 210), a configuration of the collision detection system 101 (e.g., data 220), and/or data pertaining to the operating state of the collision detection system 101 and/or vehicle 102 (e.g., data 230).

Step 820 may further comprise verifying the characteristics. The verification may include, but is not limited to: authenticating a sender of the characteristics, verifying a signature on the characteristics, receiving the characteristics via a secure communication mechanism, and so on.

Step 830 may comprise using the characteristics to determine a property of an insurance policy based, at least in part, upon the characteristics accessed at step 820. As described above, step 830 may comprise applying one or more rules 443 to the characteristics to determine the property. Alternatively, or in addition, step 830 may comprise use of one or more lookup tables, policies, expert systems, neural networks, machine-learning algorithms, or the like.

Step 830 may further comprise storing the insurance policy, and the property thereof, on a persistent storage medium. Step 830 may comprise updating a property 444 of the insurance policy data structure 442, providing the property to authorized entities 462 and/or 464 of the insured and/or insurer, receiving acceptance of the insurance policy (e.g., formalizing the insurance policy), and so on, as described above. The method ends at step 840.

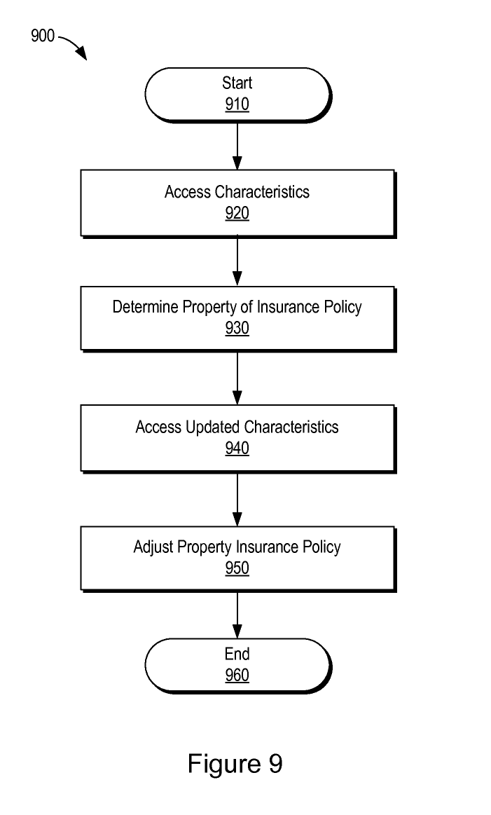

FIG. 9 illustrates a flow chart of another embodiment of a method 900 for determining a property of an insurance policy based upon information pertaining to a characteristic of a collision detection system 101. At step 910, the method 900 is started and is initialized, as described above.

Steps 920 and 930 may comprise accessing characteristics pertaining to a vehicle collision detection system 101, and determining a property of an insurance policy, as described above.

Step 930 may comprise accessing updated characteristics pertaining to the collision detection system 101 and/or vehicle 102. The characteristics of step 930 may be received in response to continuous, real-time monitoring of the collision detection system 101. As described above, the communication module 130 of the collision detection system 101 may be configured to transmit real-time configuration and/or operating state information to the insurance policy module 440 via a network 432. The updated characteristics may comprise indications of changes to the configuration of the collision detection system, usage (e.g., operating state) of the collision detection system 101 and/or vehicle 102, and so on. Alternatively, the characteristics of step 930 may be received in response to a periodic update (non-continuous and/or non-real-time); for example, in response to upgrading the collision detection system 101, reconfiguring the collision detection system 101, servicing and/or updating the vehicle 102, renewing and/or updating the insurance policy, or the like. The updated characteristics may be obtained from the storage module 150 of the collision detection system 101, from a network-accessible storage service 134, from another authorized source (e.g., entity 438), or the like. Step 940 may further comprise verifying the characteristics, as described above.

Step 950 may comprise adjusting a property of the insurance policy in response to the updated characteristics of step 940. Adjusting the property may comprise re-applying one or more rules 443, applying an expert system (or other automated process), or the like. Step 950 may further comprise storing the adjusting property on a persistent, machine-readable storage medium, generating document(s) 448 comprising the updated property, and so on. In some embodiments, the update may require acceptance from authorized entities of the insured and/or insurer 462 and/or 464. Accordingly, step 950 may comprise the formalization module 447 (or other entity) requesting and/or receiving acceptance of the adjusted property. The method ends at step 960, until further updates to the characteristics are received at step 940.

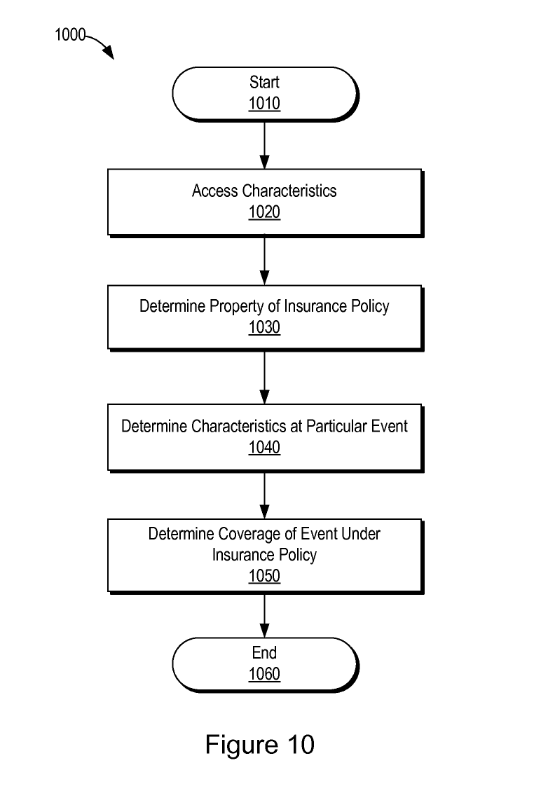

FIG. 10 illustrates a flow chart of one embodiment of a method 1000 for determining the coverage of an event under an insurance policy based, at least in part, on characteristics of a collision detection system 101 and/or vehicle 102. At step 1010, the method 1000 is started and is initialized, as described above.

Steps 1020 and 1030 may comprise accessing characteristics of a collision detection system 101 and determining a property of an insurance policy, as described above.

Step 1040 may comprise determining the characteristics of the collision detection system 101 at the time of a particular event (e.g., an accident or collision). The characteristics may comprise, inter alia, the operating state of the collision detection system 101 and/or vehicle 102 at the time of the event. The operating state may describe the capabilities of the collision detection system 101 at the time of the event (e.g., data 210), the configuration of the collision detection system 101 at the time of the event (e.g., data 220), and/or the operating state of the collision detection system 101 and/or vehicle 102 at the time of the event (e.g., data 230).

The characteristics of step 1040 may be received via a network (e.g., via the communication module 130 of the collision detection system 101), from a network-accessible service 134, may be read from storage module 150 and/or storage media 152, or the like. Step 1040 may comprise verifying the characteristics, as described above.

Step 1050 may comprise determining a property of the insurance property based, at least in part, upon the characteristics of step 1040, as described above. Step 1050 may comprise determining coverage of the insurance policy, such as a coverage amount, deductible, or the like. At step 1060, the method 1000 ends until a next event occurs and/or updated characteristics are received.

This disclosure has been made with reference to various exemplary embodiments including the best mode. However, those skilled in the art will recognize that changes and modifications may be made to the exemplary embodiments without departing from the scope of the present disclosure. For example, various operational steps, as well as components for carrying out operational steps, may be implemented in alternate ways depending upon the particular application or in consideration of any number of cost functions associated with the operation of the system (e.g., one or more of the steps may be deleted, modified, or combined with other steps).

Additionally, as will be appreciated by one of ordinary skill in the art, principles of the present disclosure may be reflected in a computer program product on a machine-readable storage medium having machine-readable program code means embodied in the storage medium. Any tangible, non-transitory machine-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create means for implementing the functions specified. These computer program instructions may also be stored in a machine-readable memory that can direct a computer or other programmable data processing apparatus to function in a particular manner, such that the instructions stored in the machine-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components that are particularly adapted for a specific environment and operating requirements may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

Those having skill in the art will appreciate that many changes may be made to the details of the above-described embodiments without departing from the underlying principles of the invention. The scope of the present invention should, therefore, be determined only by the following claims.

What is claimed is:

1. A method, comprising:
accessing electronic information pertaining to a characteristic of a collision detection system of a vehicle; and
determining, by a processor, a property of an insurance policy based upon the characteristic of the collision detection system of the vehicle, wherein the characteristic comprises an indicator of whether the collision detection system is capable of taking an automatic collision avoidance action in response to detecting a potential collision and whether the collision detection system is configured to allow automatic collision avoidance actions to be overridden.

2-12. (canceled)

13. The method of claim 1, wherein the property of the insurance policy comprises a coverage scope of the insurance policy.

14. The method of claim 1, wherein the property of the insurance policy determines a term of the insurance policy.

15. The method of claim 1, wherein the property of the insurance policy comprises eligibility for the insurance policy.

16. The method of claim 1, wherein the property of the insurance policy comprises a premium for the insurance policy.

17. The method of claim 1, wherein the property of the insurance policy comprises a coverage amount of the insurance policy.

18. The method of claim 1, wherein the property of the insurance policy comprises a coverage limitation of the insurance policy.

19. The method of claim 1, wherein the property of the insurance policy comprises a deductible of the insurance policy.

20. The method of claim 1, wherein the property of the insurance policy comprises a rider of the insurance policy.

21. The method of claim 1, wherein the property of the insurance policy comprises a limitation of the insurance policy.

22-23. (canceled)

24. The method of claim 1, wherein the characteristic comprises an identification of the collision detection system.

25-97. (canceled)

98. The method of claim 1, wherein the characteristic comprises an indication of whether the collision detection system is configured to take an automatic collision avoidance action in response to detecting a potential collision.

99-108. (canceled)

109. The method of claim 1, wherein the property of the insurance policy pertains to coverage of a particular event under the insurance policy.

110-111. (canceled)

112. The method of claim 1, wherein the characteristic indicates whether the collision detection system provided a collision avoidance instruction pertaining to the event, and wherein the characteristic indicates whether an operator of the vehicle complied with the collision avoidance instruction.

113. The method of claim 109, wherein the characteristic indicates whether the collision detection system took an automatic collision avoidance action pertaining to the event.

114. The method of claim 109, wherein the characteristic indicates whether an operator of the vehicle overrode an automatic collision avoidance action of the collision detection system pertaining to the event.

115. The method of claim 109, wherein the characteristic indicates an operating state of the collision detection system at a time of the event.

116. The method of claim 115, wherein the operating state indicates whether the collision detection system was enabled.

117. (canceled)

118. The method of claim 115, wherein the operating state indicates whether the collision detection system was configured to take automatic collision avoidance actions in response to detecting potential collisions.

119. The method of claim 118, wherein the operating state indicates whether the automatic collision avoidance actions could be overridden by an operator of the vehicle.

120-125. (canceled)

126. The method of claim 115, wherein the operating state indicates operator control inputs pertaining to the event.

127-148. (canceled)

149. A system, comprising:
a computing device comprising a processor; and
an insurance module operating on the processor of the computing device, wherein the insurance module is configured to determine a property of an insurance policy based upon a characteristic of a collision detection system of a vehicle, wherein the characteristic comprises an indication of whether the collision detection system is configured to lock one or more control inputs of the vehicle while the collision detection system takes one or more automatic collision avoidance actions in response to detecting a potential collision.

150. (canceled)

151. The system of claim 149, wherein the insurance policy insures an owner of a vehicle.

152-228. (canceled)

229. The system of claim 149, wherein the characteristic comprises an indication of whether the collision detection system is capable of taking an automatic collision avoidance action in response to detecting a potential collision.

230-231. (canceled)

232. The system of claim 229, wherein the characteristic comprises an indication of whether the automatic collision avoidance action can be overridden by an operator of the vehicle.

233-237. (canceled)

238. The system of claim 149, wherein the characteristic comprises an indication of whether the collision detection system is configured to take an automatic collision avoidance action in response to detecting a potential collision.

239-240. (canceled)

241. The system of claim 238, wherein the characteristic comprises an indication of whether the collision detection system is configured to allow the automatic collision avoidance action to be overridden.

242-245. (canceled)

246. The system of claim 149 wherein the property of the insurance policy is based upon a history of characteristics of the collision detection system.

247. The system of claim 246, wherein the history comprises an indication of a configuration of the collision detection system during an operating time of the vehicle.

248. The system of claim 246, wherein the history comprises a comparison of vehicle operating time during which the collision detection system was active to vehicle operating time during which the collision detection system was inactive.

249-269. (canceled)

270. The system of claim 149, wherein the insurance policy module is configured to adjust the property of the insurance policy upon a monitored characteristic of the collision detection system.

271. The system of claim 270, wherein the insurance policy module receives real-time information pertaining to the characteristic of the collision detection system during vehicle operation via a communication network.

272. The system of claim 271, wherein the communication network comprises a wireless data network.

273. The system of claim 271, wherein the communication network comprises a satellite communication network.

274-287. (canceled)

288. The system of claim 149, wherein the insurance policy module is configured to receive an indication that an insured and an insurer accept the property of the insurance policy.

289. A non-transitory machine-readable storage medium comprising program code configured to cause a computing device to perform a method, comprising:
accessing information pertaining to a characteristic of a collision detection system of a vehicle; and
determining a property of an insurance policy based upon the characteristic of the collision detection system of the vehicle, wherein the characteristic comprises an indication of whether the collision detection system is configured to prevent an operator of the vehicle from overriding an automatic collision avoidance action taken by the collision detection system in response to detecting a potential collision.
